(19) United States
(12) Patent Application Publication
(10) Pub. No.: US 2007/0185893 A1
(43) Pub. Date: Aug. 9, 2007

(54) Method of and a system for logging on a project which contains a footage

(76) Inventor: Steven Rosenbaum, New York, NY (US)

Correspondence Address: Ilya Zborovsky, 6 Schoolhouse Way, Dix Hills, NY, 11746, US

(21) Appl. No.: 11/285,997

(22) Filed: Nov. 25, 2005

(51) Int. Cl. G06F 7/00

(52) U.S. Cl. 707/102

(57) ABSTRACT

Logging on a project which contains a footage includes providing a web interface, placing the project on the web interface with a proposal to log on the project, submitting proposals by multiple operators to the interface expressing their willingness to log on the project or parts of it, obtaining by the operators a password, logging by the multiple operator on the project or parts of it, and downloading the logged information onto the web interface for the project or parts of it.

### BACKGROUND OF THE INVENTION

The present invention relates to a method of and a system for logging on a project which contains a footage.

Most forms of non fiction television, film, documentary content, and other footage production can be divided into two phases, namely gathering and editing. The gathering task often includes shooting hundreds of hours of raw material. This can include interviews, observational videos, verite productions, etc. in order to prepare for the editing process, all this material must be “logged”. This is a laboring intense task that requires the screening and often word-for-word transcription of all of the material into a central collection of quotes, short descriptions, and qualitative judgments. It is believed that existing process of logging can be improved.

### SUMMARY OF THE INVENTION

Accordingly, it is an object of the present invention to provide a method of and a system for logging on a project which contains a footage, which is an improvement of the existing methods and systems.

In keeping with these objects and with others which will become apparent hereinafter, one feature of the present invention resides, briefly stated, in a method of logging on a project which contains a footage, comprising the steps of providing a web interface; placing the project on the web interface with a proposal to log on the project; submitting proposals by multiple operators to the interface expressing their willingness to log on the project or parts of it; obtaining by the operators a password; logging by the multiple operator on the project or parts of it; and downloading the logged information onto the web interface for the project or parts of it.

Another feature of the present invention resides, briefly stated, in a system for logging on a project which contains a footage, comprising a web interface; means for submitting a project onto said web interface to log on the project; means for submitting proposals by multiple operators to said web interface expressing their willingness to log on the project or part of it; means for obtaining by the operators a password; means for logging by the multiple operators on the same project or parts of it; and means for downloading logged information on said web interface for the project or parts of it.

Still another feature of the present invention resides, briefly stated, in a computer readable medium for implementing a method of logging on a project which contains a footage and comprising the steps of providing a web interface; placing the project on the web interface with a proposal to log on the project; submitting proposals by multiple operators to the interface expressing their willingness to log on the project or parts of it; obtaining by the operators a password; logging by the multiple operator on the project or parts of it; and downloading the logged information for the project or parts of it onto the web interface.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a block diagram schematically illustrating an exemplary computer network for implementing the present invention; and

FIG. 2 is a flow chart of an exemplary process for implementing a method of and a system for logging on a project which contains a footage in accordance with the present invention.

### DESCRIPTION OF THE PREFERRED EMBODIMENTS

In accordance with the method and system of the present invention a computer network site is provided. The network site may be for example, a website accessible over the internet or worldwide web.

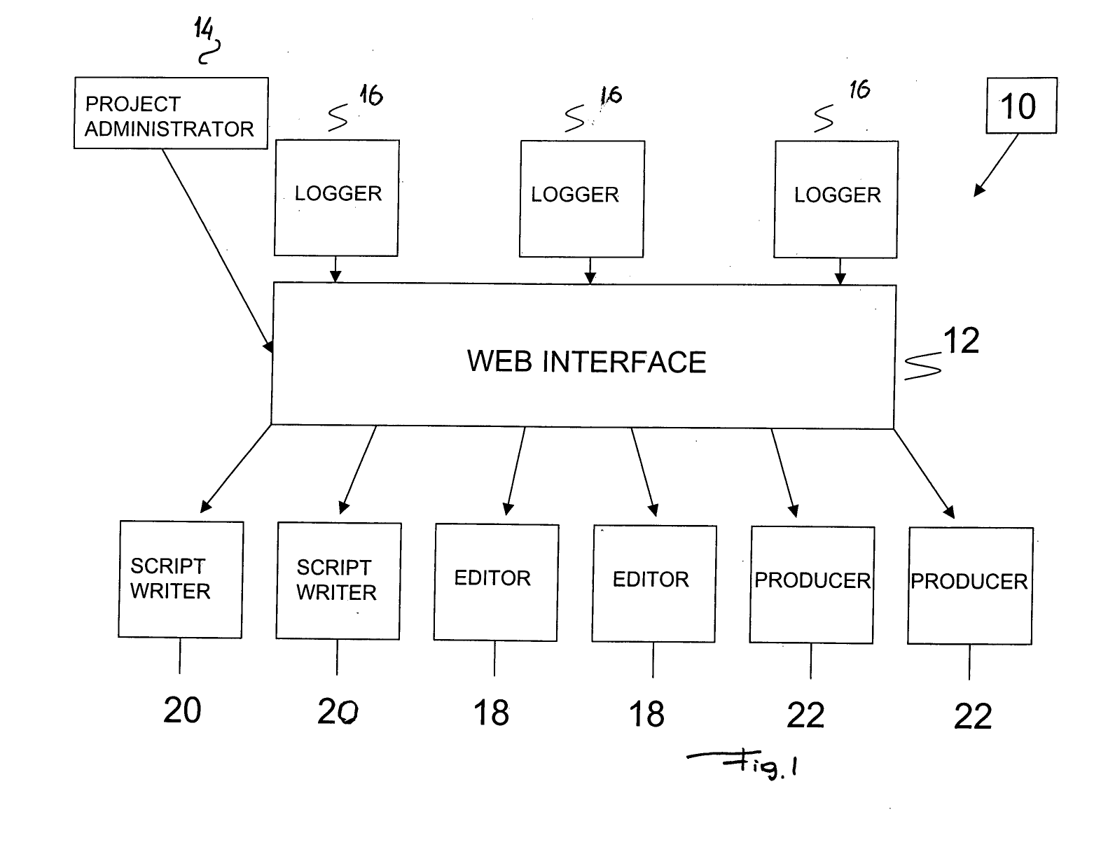

Referring now to FIG. 1, it shows an exemplary system 10 for the present invention. A network connection formed as a web interface is identified with reference numeral 12. A project administrator's terminal is identified with reference numeral 14. The project administrator transmits through the project administrator's terminal 14 a project in form of a footage to the web interface 12, with invitation or announcement that operators or loggers are invited to log on the project or footage as a whole or on parts of it.

Operators or loggers terminals are identified with reference numeral 16. Operators or loggers submit to the web interface 12 a response that they are willing to log on the project or part of it. The project administrator through his terminal 14 provides a password to each of the loggers, which is sent to their terminals 16.

The loggers through their terminal 16 log on the project or on parts of the project in form of the footage in the web interface 12. They then download the logged information, possibly working at multiple locations, onto the web interface 12.

The logged project or the logged parts of the project can be used further. In particular, editors through editors terminals 18 can edit the logged project or the logged parts of the project, script writers through their terminals 20 can write the scripts based on the logged project or logged parts of it, producers through their terminals 22 can produce corresponding works based on the logged project or logged parts of it.

For the logged parts of the project or video product, meta data can be provided, so as to make them accessible for a future search and sorting of related video data. On the other hand, for unlogged parts of the video product, also meta data can be provided, so as to make the unlogged parts of the video product also accessible for a future search and sorting of related video data.

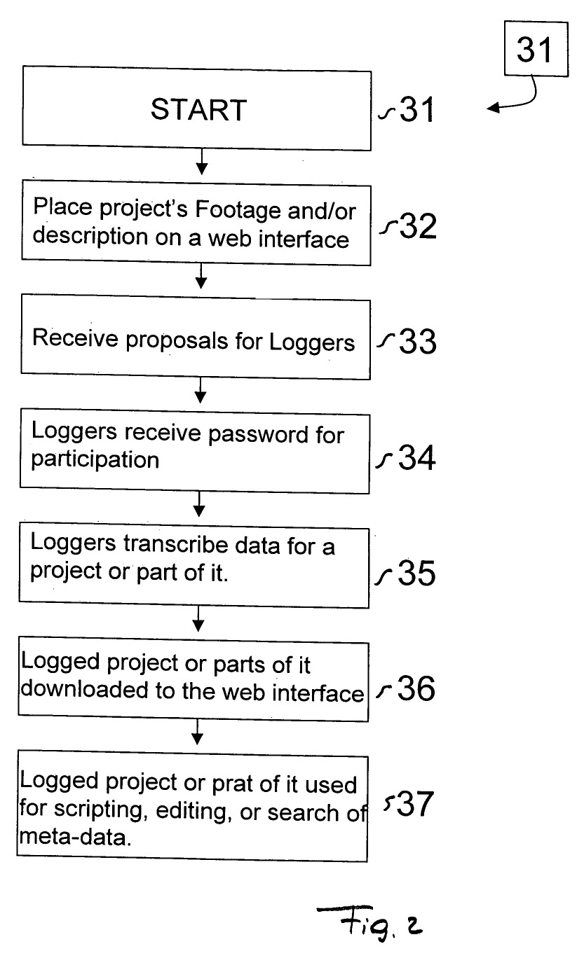

Turning now to FIG. 2, this figure represents an exemplary process 30 for logging on a project which contains a footage. The process 30 begins at a start point 31. In step 32 a project administrator places the project or in other words projects footage on the web interface 12. In step 33 proposals are obtained from operators or loggers who are willing to log on the project or parts of it. After this, in step 34 the loggers receive a password for logging from the project administrator.

Loggers then log on the projects or on the parts of it, as shown in step 35. They can operate at multiple locations. When the logging process is finished, the logged information for the logged project or the logged parts of the project are downloaded on the web interface in step 36. The logged project or the logged parts of it can be used for a further use, such as for scripting, editing, producing a video product, etc, as identified in step 37.

In the system and method in accordance with the present invention, an extraordinary tool is provided for the peer production of video content. They allow for shared and efficient workflow across a team of video makers. It creates a shared resource for complex projects with multiple shooter/producer teams and remote production units.

It will be understood that each of the elements described above, or two or more together, may also find a useful application in other types of methods and constructions differing from the types described above.

While the invention has been illustrated and described as embodied in a method of and a system for logging on a project which contains a footage, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of logging on a project which contains a footage, comprising the steps of providing a web interface; placing the project on the web interface with a proposal to log on the project; submitting proposals by multiple operators to the interface expressing their willingness to log on the project or parts of it; obtaining by the operators a password; logging by the multiple operator on the project or parts of it; and downloading the logged information for the project or parts of it onto the web interface.

2. A method as defined in claim 1; wherein said downloading includes downloading of the logged information from multiple locations.

3. A method as defined in claim 1; and further comprising scripting and editing the logged information to make a script and to edit it so as to form a finished film product.

4. A method as defined in claim 1; and further comprising providing a meta-data for logged parts of the project so as to make them accessible for a future search and sorting of related video data.

5. A method as defined in claim 1; and further comprising a meta-data for unlogged parts of the video product so as to make them accessible for a future search and sorting of related video data.

6. A system for logging on a project which contains a footage, comprising a web interface; means for submitting a project onto said web interface with a proposal to log on the project; means for submitting proposals by multiple operators to said web interface expressing their willingness to log on the project or part of it; means for obtaining by the operators a password; means for logging by the multiple operators on the same project or parts of it; and means for downloading logged information for the project or parts of it on said web interface.

7. A computer readable medium for implementing a method of logging on a project which contains a footage and comprising the steps of providing a web interface; placing the project on the web interface with a proposal to log on the project; submitting proposals by multiple operators to the interface expressing their willingness to log on the project or parts of it; obtaining by the operators a password; logging by the multiple operator on the project or parts of it; and downloading the logged information for the project or parts of it onto the web interface of it.
